(19) United States
(12) Patent Application Publication
(10) Pub. No.: US 2007/0270026 A1
(43) Pub. Date: Nov. 22, 2007

(54) Computer enclosure with direct external connection with sata-interfaced hard disk drive

(75) Inventor: Wentai Lo, Taichung (TW)

Correspondence Address: LEONG C LEI, PMB # 1008, 1867 YGNACIO VALLEY ROAD, WALNUT CREEK, CA, 94598, US

(73) Assignee: LOGIC CONCEPT TECHNOLOGY CO., LTD., Taichung (TW)

(21) Appl. No.: 11/434,162

(22) Filed: May 16, 2006

(51) Int. Cl. H01R 12/24

(52) U.S. Cl. 439/499

(57) ABSTRACT

A computer enclosure includes a SATA-interfaced HDD connector formed thereon for direct and releasable connection with an external SATA-interfaced HDD. The connector is electrically connected to a main board and a power supply arranged inside the enclosure and forms a power cable connection socket and a signal cable connection socket that are releasably engagable with end connectors of a flat power cable and a flat signal cable from the external SATA-interfaced HDD. Thus, the SATA-interfaced HDD is electrically connectable to the main board of the computer in an external HDD case free manner.

### BACKGROUND OF THE INVENTION

1. Field of the Invention

The present invention relates to a computer enclosure that can directly and externally connect with a serial ATA (SATA) interfaced hard disk drive (HDD) without use of an external HDD case.

2. The Related Art

Portable computers, such as notebook computers, allow for portability of computer data storage. However, as compared with desktop computers, the notebook computers are expensive. In other words, the desktop computers are advantageous in cost, as well as performance. Thus, to provide data storage portability, removable external HDDs are available in the market. FIG. 1A shows an example of the removable external HDD, wherein a conventional ATA HDD 10 is received and fixed in an external HDD case 1 and is releasably connected to a computer enclosure 2 via for example a USB cable 11. This measure meets the needs of most computer users and related products are prevailing in the market.

However, the HDD that is contained in the conventional HDD case 1 is an ATA HDD 10 having an IDF interface, which requires thick and bulky power cable and flat signal cable. Further, such a conventional technique does not support hot plugging and consumes a great amount of power. Thus, the heavy and bulky case 1 becomes a must in such an external HDD technique, which certainly causes problems to the general consumers.

As compared with the IDF interface, a serial ATA (SATA) interface allows the HDDs to operate in a higher speed. For example, an IDF HDD can have a maximum speed of 133 MHz, while the SATA HDD can be of a minimum speed of 150 MHz. Further, the SATA HDD can use thin and slender power cable and flat signal cable, and has improved heat dissipation characteristics and lower power consumption, and is thus more than welcome in the art.

However, the SATA HDD that is currently available in the market is still of the same old-fashioned configuration and is often used as a built-in device of both desktop computers and notebook computers, or a HDD case is needed to serve as an external device, as illustrated in FIG. 1B. This prevents the SATA HDD from fully exploiting its potential in providing a better portable data storage device.

Thus, it is desired to have a HDD case that overcomes the above discussed drawbacks and takes full advantages of the SATA device.

### SUMMARY OF THE INVENTION

The present invention provides is aimed to provide a computer enclosure with direct external connection with a SATA-interfaced HDD, wherein the enclosure forms a SATA-interfaced HDD connector that is electrically connected to a main board and a power supply of the computer, and forms flat cable connection sockets for receiving and connecting end connectors of a flat power cable and a flat signal cable from a SATA-interface HDD.

### BRIEF DESCRIPTION OF THE DRAWINGS

The present invention will be apparent to those skilled in the art by reading the following description of preferred embodiments thereof, with reference to the attached drawings, in which:

FIG. 1A is a perspective view showing the connection between a conventional external IDF HDD case and a computer enclosure;

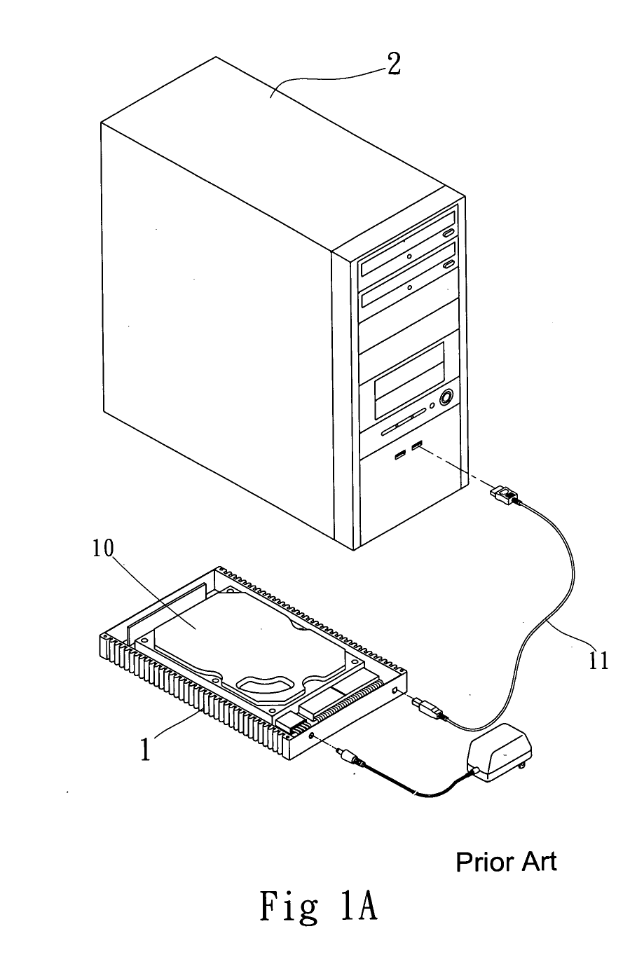

FIG. 1B is a perspective view showing the connection between a conventional external SATA HDD case and a computer enclosure;

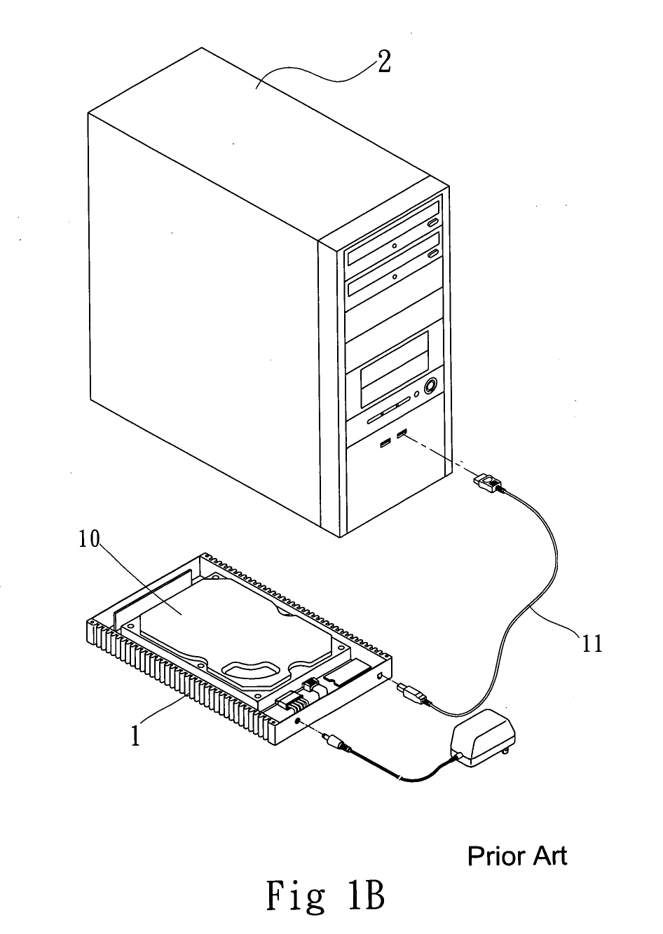

FIG. 2 is a perspective view showing a computer enclosure in accordance with an embodiment of the present invention having a front panel forming a connection socket for receiving end connectors of flat cables from an external SATA-interfaced HDD;

FIG. 3 is a perspective view showing a computer enclosure in accordance with another embodiment of the present invention having a back panel forming a connection socket for receiving end connectors of flat cables from an external SATA-interfaced HDD;

FIG. 4 is a perspective view showing a computer enclosure in accordance with another embodiment of the present invention having a two wall forming a connection socket for receiving end connectors of flat cables from an external SATA-interfaced HDD; and

FIG. 5 is a perspective view showing a computer enclosure in accordance with another embodiment of the present invention having a side wall forming a connection socket for receiving end connectors of flat cables from an external SATA-interfaced HDD.

### DETAILED DESCRIPTION OF THE PREFERRED EMBODIMENTS

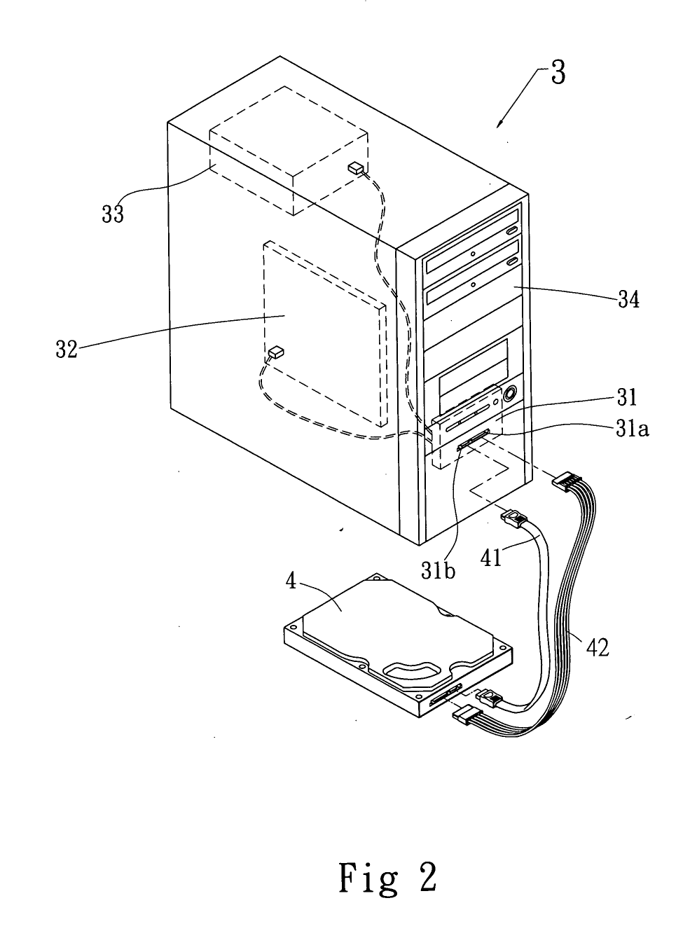

With reference to the drawings and in particular to FIG. 2, a computer enclosure constructed in accordance with an embodiment of the present invention, generally designated with reference numeral 3, comprises a SATA-interface HDD connector 31 formed on any suitable location of the enclosure 3 for releasable connection with an external SATA-interface HDD 4. The SATA-interface connector 31 is electrically connected to a main board 32 and a power supply 33 arranged inside the enclosure 3, and also forms a connection socket 31a for an end connector of a flat power cable 42 of the SATA-interfaced HDD 4 and a connection socket 31b for an end connector of a flat signal cable 41 of the SATA-interfaced HDD 4.

With this arrangement, a computer user can directly connect a SATA-interfaced HDD 4 with the computer enclosure 3 via the SATA-interfaced HDD connector 31 without use of an external HDD case so that the HDD 4 can be electrically connected to the main board 32 and the power supply 33 inside the enclosure 3 for the most convenient use of the HDD 4.

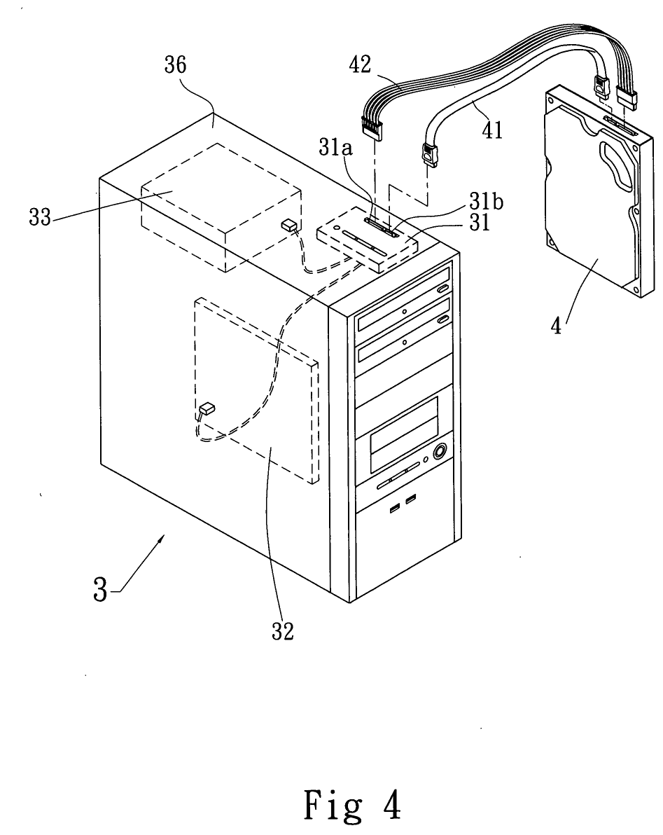

In the embodiment illustrated in FIG. 4, the enclosure 3 has a front panel 34 on which the SATA-interfaced HDD connector 31 is formed.

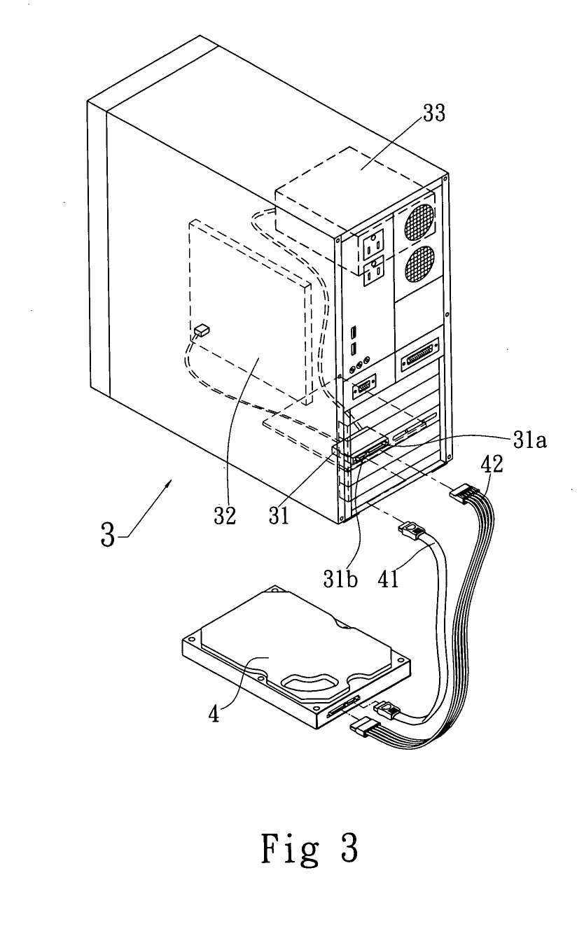

However, it is apparent to those having ordinary skills to arrange the SATA-interfaced HDD connector 31 on other portions of the enclosure 3. For example, and as shown in FIG. 3, the enclosure 3 has a back panel 35 and the SATA-interfaced HDD connector 31 is formed on the back panel 35 and is electrically connected to the main board 32 and the power supply 33 inside the enclosure 3. Similarly, the SATA-interfaced HDD connector 31 on the back panel is comprised of a power cable connection socket 31b to receive the end connector of the flat power cable 41 of the SATA-interfaced HDD 4 and a signal cable connection socket 31a to receive the end connector of the flat signal cable 42 of the SATA-interfaced HDD 4.

In another embodiment of the present invention shown in FIG. 4, the enclosure 3 has a top wall 36 and the SATA-interfaced HDD connector 31 is formed on the top wall 36 and is electrically connected to the main board 32 and the power supply 33 inside the enclosure 3. Similarly, the SATA-interfaced HDD connector 31 on the top wall is comprised of a power cable connection socket 31b to receive the end connector of the flat power cable 41 of the SATA-interfaced HDD 4 and a signal cable connection socket 31a to receive the end connector of the flat signal cable 42 of the SATA-interfaced HDD 4.

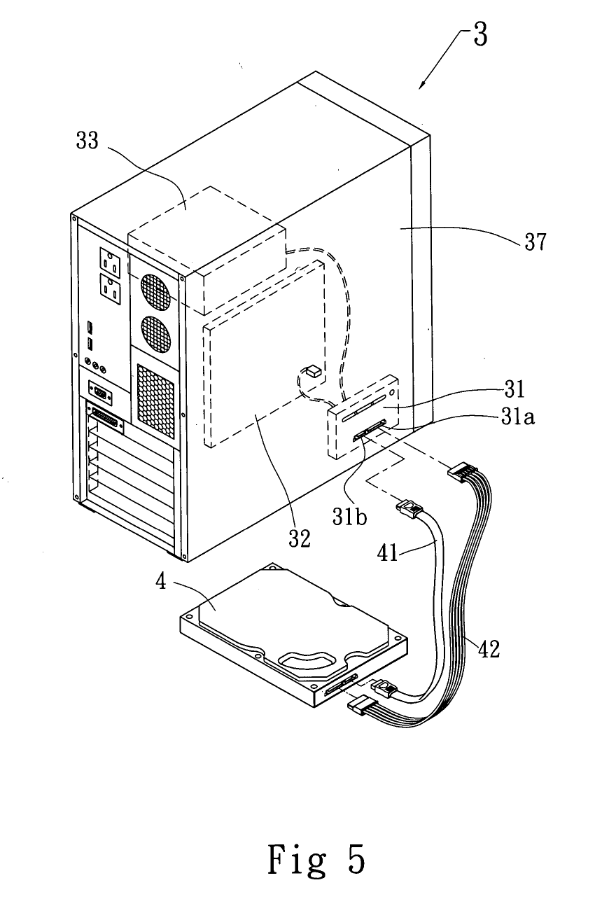

In a further embodiment of the present invention shown in FIG. 5, the enclosure 3 has a side wall 37 and the SATA-interfaced HDD connector 31 is formed on the side wall 37 and is electrically connected to the main board 32 and the power supply 33 inside the enclosure 3. Similarly, the SATA-interfaced HDD connector 31 on the side wall is comprised of a power cable connection socket 31b to receive the end connector of the flat power cable 41 of the SATA-interfaced HDD 4 and a signal cable connection socket 31a to receive the end connector of the flat signal cable 42 of the SATA-interfaced HDD 4.

Although the present invention has been described with reference to the preferred embodiments with reference to the drawings thereof, it is apparent to those skilled in the art that a variety of modifications and changes may be made without departing from the scope of the present invention which is intended to be defined by the appended claims.

1: A computer enclosure comprising an external wall member on which a SATA-interfaced HDD connector is formed for direct and releasable connection with an external SATA-interfaced HDD, the connector being adapted to electrically connect to a main board and a power supply arranged inside the enclosure and forming a power cable connection device and a signal cable connection device adapted to releasably connect a flat power cable and a flat signal cable from the external SATA-interfaced HDD whereby the SATA-interfaced HDD is electrically connectable to the main board in an external HDD case free manner.

2: The computer enclosure as claimed in claim 1, wherein the external wall of the enclosure comprises a front panel on which the SATA-interfaced HDD connector is formed.

3: The computer enclosure as claimed in claim 1, wherein the external wall of the enclosure comprises a back panel on which the SATA-interfaced HDD connector is formed.

4: The computer enclosure as claimed in claim 1, wherein the external wall of the enclosure comprises a top wall on which the SATA-interfaced HDD connector is formed.

5: The computer enclosure as claimed in claim 1, wherein the external wall of the enclosure comprises a side wall on which the SATA-interfaced HDD connector is formed.
